(19) United States
(12) Patent Application Publication
(10) Pub. No.: US 2023/0214399 A1
(43) Pub. Date: Jul. 6, 2023

(54) PATENT SEARCH SYSTEM AND METHOD THEREOF

(71) Applicant: KKLAB TECHNOLOGIES PTE. LTD., Taipei City (TW)

(72) Inventors: Shih Chun Lu, Taipei City (TW); Shih Hung Lin, Taipei City (TW); Sheng Fu Lin, Taipei City (TW)

(73) Assignee: KKLAB TECHNOLOGIES PTE. LTD., Taipei City (TW)

(21) Appl. No.: 17/841,159

(22) Filed: Jun. 15, 2022

(30) Foreign Application Priority Data
Jan. 3, 2022 (TW) 111100151

(51) Int. Cl. G06F 16/2457

(52) U.S. Cl. CPC G06F 16/24578; G06F 2216/11

(57) ABSTRACT

The present invention provides a patent search system, comprising: a database storing a plurality of first patent document data items; and a server accessing the database, the server receiving a first search criterion instruction and then retrieving a plurality of second patent document data items from the plurality of first patent document data items based on the first search criterion instruction, wherein the server receives a first selection instruction associated with a first selected patent document data item in the plurality of second patent document data items, obtains a first patent classification code data item from the first selected patent document data item based on the first selection instruction, and generates a second search criterion instruction based on at least the first search criterion instruction and the first patent classification code data item, the second search criterion instruction including the first patent classification code data item, wherein the server retrieves a plurality of third patent document data items from the plurality of first patent document data items based on the second search criterion instruction, and at least one of the plurality of third patent document data items contains the first patent classification code data item, wherein the first search criterion instruction indicates a first search criterion, and the server retrieves the plurality of second patent document data items from the plurality of first patent document data items on the basis that the plurality of second patent document data items all meet the first search criterion, wherein the second search criterion instruction indicates a second search criterion, and the server retrieves the plurality of third patent document data items from the plurality of first patent document data items on the basis that the plurality of third patent document data items all meet the second search criterion, and wherein the first selection instruction is associated with a first related-tag data item.

### TECHNICAL FIELD

This application is claims priority under 35 U.S.C. § 119 to Taiwanese Patent Application No. 111100151, filed Jan. 3, 2022, the entirety of which is incorporated by reference herein.

The present invention relates to a patent search system and a method thereof, and more particularly to a patent search system and a patent search method for the system that may assist users in patent searches based on selection instructions.

### BACKGROUND

A patent search system is a type of search system specifically used for searching patent documents. Since the contents of patent documents contain professional knowledge of various fields, and since the writing style and format of patent documents are different to those of ordinary documents, in most cases, ordinary users would not know how to conduct patent searches properly or could otherwise have problems finding the precise group of patents being targeted, unless they have acquired certain knowledge of the patent system or have a certain degree of understanding of the technical field to which the target patents (i.e., the group of patents they try to search for) pertain. In addition, as described above, since the contents, writing style and format of patent documents are different to those of ordinary documents, a general-purpose search system (such as Google) is not a suitable tool for patent searches. In this light, it is needed to have a patent search system and a patent search method for the system that can assist ordinary users (those who have not acquired patent knowledge) in patent searches.

### SUMMARY

To solve the problems described above, one idea of the present invention is to provide a patent search system and a method for the system that may assist users in patent searches. Another idea of the present invention is to provide a patent search system and a method for the system that may assist users in patent searches based on selection instructions.

Based on the ideas described above, the present invention provides a patent search system, comprising: a database storing a plurality of first patent document data items; and a server accessing the database, the server receiving a first search criterion instruction and then retrieving a plurality of second patent document data items from the plurality of first patent document data items based on the first search criterion instruction, wherein the server receives a first selection instruction associated with a first selected patent document data item in the plurality of second patent document data items, obtains a first patent classification code data item from the first selected patent document data item based on the first selection instruction, and generates a second search criterion instruction based on at least the first search criterion instruction and the first patent classification code data item, the second search criterion instruction including the first patent classification code data item, wherein the server retrieves a plurality of third patent document data items from the plurality of first patent document data items based on the second search criterion instruction, and at least one of the plurality of third patent document data items contains the first patent classification code data item, wherein the first search criterion instruction indicates a first search criterion, and the server retrieves the plurality of second patent document data items from the plurality of first patent document data items on the basis that the plurality of second patent document data items all meet the first search criterion, wherein the second search criterion instruction indicates a second search criterion, and the server retrieves the plurality of third patent document data items from the plurality of first patent document data items on the basis that the plurality of third patent document data items all meet the second search criterion, and wherein the first selection instruction is associated with a first related-tag data item.

In a preferred embodiment of the present invention, the first patent classification code data item is one of a second-level patent classification code data item, a third-level patent classification code data item, a fourth-level patent classification code data item, and a fifth-level patent classification code data item.

In a preferred embodiment of the present invention, the server obtains a second patent classification code data item from the first selected patent document data item based on the first selection instruction, wherein the server generates the second search criterion instruction based on at least the first search criterion instruction, the first patent classification code data item, and the second patent classification code data item, and the second search criterion instruction includes the second patent classification code data item, and wherein at least one of the plurality of third patent document data items contains the second patent classification code data item.

In a preferred embodiment of the present invention, the server receives a second selection instruction associated with a second selected patent document data item in the plurality of second patent document data items, and the server obtains a third patent classification code data item from the second selected patent document data item based on the second selection instruction, wherein the server generates the second search criterion instruction based on at least the first search criterion instruction, the first patent classification code data item, and the third patent classification code data item, and the second search criterion instruction includes the third patent classification code data item, wherein at least one of the plurality of third patent document data items contains the third patent classification code data item, and wherein the second selection instruction is associated with a second related-tag data item.

In a preferred embodiment of the present invention, the server receives a second selection instruction associated with a second selected patent document data item in the plurality of second patent document data items, and the server obtains a third patent classification code data item from the second selected patent document data item based on the second selection instruction, wherein the server generates the second search criterion instruction based on at least the first search criterion instruction, the first patent classification code data item, and the third patent classification code data item, and the second search criterion instruction includes the third patent classification code data item, wherein at least one of the plurality of third patent document data items contains the third patent classification code data item, and wherein the second selection instruction is associated with a second related-tag data item. In addition, the server obtains a fourth patent classification code data item from the second selected patent document data item based on the second selection instruction, wherein the server generates the second search criterion instruction based on at least the first search criterion instruction, the first patent classification code data item, the third patent classification code data item, and the fourth patent classification code data item, and the second search criterion instruction includes the fourth patent classification code data item, and wherein at least one of the plurality of third patent document data items contains the fourth patent classification code data item.

In a preferred embodiment of the present invention, the server obtains a keyword data item from the first selected patent document data item based on the first selection instruction, and the server generates the second search criterion instruction based on at least the first search criterion instruction, the first patent classification code data item, and the keyword data item, the second search criterion instruction including the keyword data item.

In a preferred embodiment of the present invention, the server retrieves a plurality of fourth patent document data items based on the first search criterion instruction and generates a classification ranking data item based on the plurality of fourth patent document data items, the classification ranking data item indicating a proportion ranking of different patent classification codes in the plurality of fourth patent document data items, wherein the server retrieves the plurality of second patent document data items from the plurality of first patent document data items based on the first search criterion instruction, the classification ranking data item, and a predetermined percentage data item, and wherein the plurality of fourth patent document data items include the plurality of second patent document data items.

In a preferred embodiment of the present invention, the server retrieves a plurality of fourth patent document data items based on the first search criterion instruction and generates a classification ranking data item based on the plurality of fourth patent document data items, the classification ranking data item indicating a proportion ranking of different patent classification codes in the plurality of fourth patent document data items, wherein the server retrieves the plurality of second patent document data items from the plurality of first patent document data items based on the first search criterion instruction, the classification ranking data item, and a predetermined percentage data item, and wherein the plurality of fourth patent document data items include the plurality of second patent document data items. In addition, the plurality of second patent document data items include a plurality of fifth patent document data items, a plurality of sixth patent document data items, and a plurality of seventh patent document data items, each of the plurality of fifth patent document data items contains a fifth patent classification code data item, each of the plurality of sixth patent document data items contains a sixth patent classification code data item, and each of the plurality of seventh patent document data items contains a seventh patent classification code data item, wherein the fifth patent classification code data item ranks first in the classification ranking data item, the sixth patent classification code data item ranks second in the classification ranking data item, and the seventh patent classification code data item ranks third in the classification ranking data item, and wherein at least one of the plurality of second patent document data items contains the fifth patent classification code data item, at least one of the plurality of second patent document data items contains the sixth patent classification code data item, and at least one of the plurality of second patent document data items contains the seventh patent classification code data item.

In a preferred embodiment of the present invention, the server receives a third selection instruction associated with a third selected patent document data item in the plurality of third patent document data items and obtains an eighth patent classification code data item from the third selected patent document data item based on the third selection instruction, and the server generates a third search criterion instruction based on at least the first search criterion instruction and the eighth patent classification code data item, the third search criterion instruction including the eighth patent classification code data item, wherein the third selection instruction is associated with a third related-tag data item, wherein the server retrieves a plurality of eighth patent document data items from the plurality of first patent document data items based on the third search criterion instruction, and at least one of the plurality of eighth patent document data items contains the eighth patent classification code data item, wherein the third search criterion instruction indicates a third search criterion, and the server retrieves the plurality of eighth patent document data items from the plurality of first patent document data items on the basis that the plurality of eighth patent document data items all meet the third search criterion, and wherein the first patent classification code data item indicates a first patent classification code, and the eighth patent classification code data item indicates an eighth patent classification code, which belongs to a further detailed classification under the first patent classification code in a hierarchy.

According to an objective of the present invention, a patent search method for use in a patent search system is provided, the patent search system comprising a database and a server, the database storing a plurality of first patent document data items, the server accessing the database, the patent search method including the steps of: receiving, by the server, a first search criterion instruction and retrieving a plurality of second patent document data items from the plurality of first patent document data items based on the first search criterion instruction; receiving, by the server, a first selection instruction associated with a first selected patent document data item in the plurality of second patent document data items; obtaining, by the server, a first patent classification code data item from the first selected patent document data item based on the first selection instruction; generating, by the server, a second search criterion instruction based on at least the first search criterion instruction and the first patent classification code data item, the second search criterion instruction including the first patent classification code item; and retrieving, by the server, a plurality of third patent document data items from the plurality of first patent document data items based on the second search criterion instruction, at least one of the plurality of third patent document data items containing the first patent classification code data item, wherein the first search criterion instruction indicates a first search criterion, and the server retrieves the plurality of second patent document data items from the plurality of first patent document data items on the basis that the plurality of second patent document data items all meet the first search criterion, wherein the second search criterion instruction indicates a second search criterion, and the server retrieves the plurality of third patent document data items from the plurality of first patent document data items on the basis that the plurality of third patent document data items all meet the second search criterion, and wherein the first selection instruction is associated with a first related-tag data item.

In a preferred embodiment of the present invention, the first patent classification code data item is one of a second-level patent classification code data item, a third-level patent classification code data item, a fourth-level patent classification code data item, and a fifth-level patent classification code data item.

In a preferred embodiment of the present invention, the patent search method further includes: obtaining, by the server, a second patent classification code data item from the first selected patent document data item based on the first selection instruction, wherein the server generates the second search criterion instruction based on at least the first search criterion instruction, the first patent classification code data item, and the second patent classification code data item, and the second search criterion instruction includes the second patent classification code data item, and wherein at least one of the plurality of third patent document data items contains the second patent classification code data item.

In a preferred embodiment of the present invention, the patent search method further includes: receiving, by the server, a second selection instruction associated with a second selected patent document data item in the plurality of second patent document data items; and obtaining, by the server, a third patent classification code data item from the second selected patent document data item based on the second selection instruction, wherein the server generates the second search criterion instruction based on at least the first search criterion instruction, the first patent classification code data item, and the third patent classification code data item, and the second search criterion instruction includes the third patent classification code data item, wherein at least one of the plurality of third patent document data items contains the third patent classification code data item, and wherein the second selection instruction is associated with a second related-tag data item.

In a preferred embodiment of the present invention, the patent search method further includes: receiving, by the server, a second selection instruction associated with a second selected patent document data item in the plurality of second patent document data items; and obtaining, by the server, a third patent classification code data item from the second selected patent document data item based on the second selection instruction, wherein the server generates the second search criterion instruction based on at least the first search criterion instruction, the first patent classification code data item, and the third patent classification code data item, and the second search criterion instruction includes the third patent classification code data item, wherein at least one of the plurality of third patent document data items contains the third patent classification code data item, and wherein the second selection instruction is associated with a second related-tag data item. In addition, the patent search method further includes: obtaining, by the server, a fourth patent classification code data item from the second selected patent document data item based on the second selection instruction, wherein the server generates the second search criterion instruction based on at least the first search criterion instruction, the first patent classification code data item, the third patent classification code data item, and the fourth patent classification code data item, and the second search criterion instruction includes the fourth patent classification code data item, and wherein at least one of the plurality of third patent document data items contains the fourth patent classification code data item.

In a preferred embodiment of the present invention, the patent search method further includes: obtaining, by the server, a keyword data item from the first selected patent document data item based on the first selection instruction, wherein the server generates the second search criterion instruction based on at least the first search criterion instruction, the first patent classification code data item, and the keyword data item, the second search criterion instruction including the keyword data item.

In a preferred embodiment of the present invention, the patent search method further includes: retrieving, by the server, a plurality of fourth patent document data items based on the first search criterion instruction; and generating, by the server, a classification ranking data item based on the plurality of fourth patent document data items, the classification ranking data item indicating a proportion ranking of different patent classification codes in the plurality of fourth patent document data items, wherein the server retrieves the plurality of second patent document data items from the plurality of first patent document data items based on the first search criterion instruction, the classification ranking data item, and a predetermined percentage data item, and wherein the plurality of fourth patent document data items include the plurality of second patent document data items.

In a preferred embodiment of the present invention, the patent search method further includes: retrieving, by the server, a plurality of fourth patent document data items based on the first search criterion instruction; and generating, by the server, a classification ranking data item based on the plurality of fourth patent document data items, the classification ranking data item indicating a proportion ranking of different patent classification codes in the plurality of fourth patent document data items, wherein the server retrieves the plurality of second patent document data items from the plurality of first patent document data items based on the first search criterion instruction, the classification ranking data item, and a predetermined percentage data item, and wherein the plurality of fourth patent document data items include the plurality of second patent document data items. In addition, the plurality of second patent document data items include a plurality of fifth patent document data items, a plurality of sixth patent document data items, and a plurality of seventh patent document data items, each of the plurality of fifth patent document data items contains a fifth patent classification code data item, each of the plurality of sixth patent document data items contains a sixth patent classification code data item, and each of the plurality of seventh patent document data items contains a seventh patent classification code data item, wherein the fifth patent classification code data item ranks first in the classification ranking data item, the sixth patent classification code data item ranks second in the classification ranking data item, and the seventh patent classification code data item ranks third in the classification ranking data item, and wherein at least one of the plurality of second patent document data items contains the fifth patent classification code data item, at least one of the plurality of second patent document data items contains the sixth patent classification code data item, and at least one of the plurality of second patent document data items contains the seventh patent classification code data item.

In a preferred embodiment of the present invention, the patent search method further includes: receiving, by the server, a third selection instruction associated with a third selected patent document data item in the plurality of third patent document data items; obtaining, by the server, an eighth patent classification code data item from the third selected patent document data item based on the third selection instruction; generating, by the server, a third search criterion instruction based on at least the first search criterion instruction and the eighth patent classification code data item, the third search criterion instruction including the eighth patent classification code data item; and retrieving, by the server, a plurality of eighth patent document data items from the plurality of first patent document data items based on the third search criterion instruction, at least one of the plurality of eighth patent document data items containing the eighth patent classification code data item, wherein the third selection instruction is associated with a third related-tag data item, wherein the third search criterion instruction indicates a third search criterion, and the server retrieves the plurality of eighth patent document data items from the plurality of first patent document data items on the basis that the plurality of eighth patent document data items all meet the third search criterion, and wherein the first patent classification code data item indicates a first patent classification code, and the eighth patent classification code data item indicates an eighth patent classification code, which belongs to a further detailed classification under the first patent classification code in a hierarchy.

These and other aspects of the invention will be apparent upon reference to the following detailed description of non-limiting exemplary embodiments and the accompanying drawings.

### BRIEF DESCRIPTION OF THE DRAWINGS

FIG. 1 is a system architecture diagram of a patent search system according to an embodiment of the present invention.

FIG. 2A is a schematic view of the patent search system according to an embodiment of the present invention.

FIG. 2B is a schematic view of the patent search system according to an embodiment of the present invention.

FIG. 3A is a schematic view of the patent search system according to an embodiment of the present invention.

FIG. 3B is a schematic view of the patent search system according to an embodiment of the present invention.

FIG. 4A is a schematic view of the patent search system according to an embodiment of the present invention.

FIG. 4B is a schematic view of the patent search system according to an embodiment of the present invention.

FIG. 5A is a schematic view of the patent search system according to an embodiment of the present invention.

FIG. 5B is a schematic view of the patent search system according to an embodiment of the present invention.

FIG. 6A is a schematic view of the patent search system according to an embodiment of the present invention.

FIG. 6B is a schematic view of the patent search system according to an embodiment of the present invention.

FIG. 7 is a schematic view of the patent search system according to an embodiment of the present invention.

FIG. 8 is a flow chart showing the patent search method according to an embodiment of the present invention.

### DETAILED DESCRIPTION

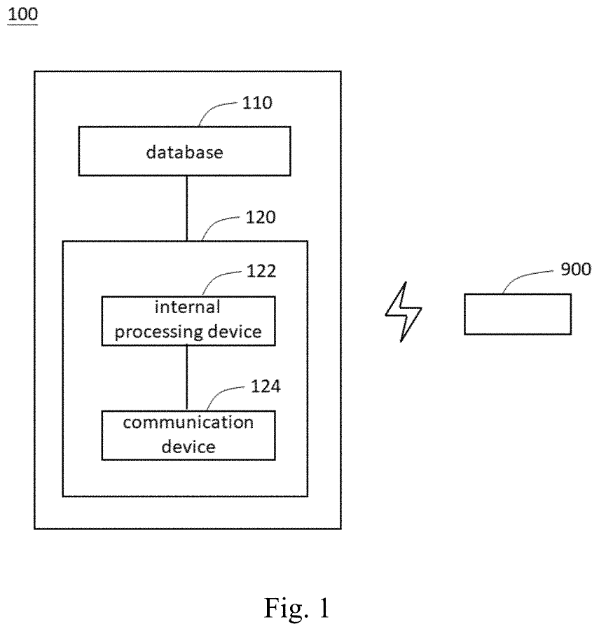

Please refer to FIG. 1, which shows a system architecture diagram of a patent search system according to an embodiment of the present invention. As the embodiment illustrated in FIG. 1 shows, a patent search system 100 includes a database 110 and a server 120. The server 120 accesses (or is communicatively connected to) the database 110, and the server 120 can be communicatively connected to one or more user devices 900. The user device 900 may be, for example, but is not limited to, a computer, a tablet computer, a mobile device, and the like; the user device 900 may have a display unit (e.g., a display screen). Therefore, the server 120 can display various data or instructions to the user through the display unit of the user device 900. In one embodiment, the server 120 is communicatively connected to the user device 900 via a network (e.g., a wired network or a wireless network). In one embodiment, the patent search system 100 of the present invention includes one or more processors, and the patent search system 100 implements functions of the database 110 and/or the server 120 by enabling coordination between the hardware and software. In one embodiment, the user device 900 may include one or more processors, and the user device 900 sends, receives and processes various data or instructions by enabling coordination between the hardware and software.

In one embodiment, the server 120 may include an internal processing device 122 and a communication device 124. The internal processing device 122 is communicatively connected to the communication device 124 and the database 110, the database 110 is communicatively connected to the communication device 124, and the server 120 can be communicatively connected to the user device 900 through the communication device 124. The server 120 receives various data or instructions from the user device 900 through the communication device 124, and sends various data or instructions to the user device 900 through the communication device 124. In addition, the server 120 processes various data or instructions through the internal processing device 122. Preferably, the server 120 includes one or more processors and implements functions of the internal processing device 122 and/or the communication device 124 by enabling coordination between the hardware and software.

In the embodiment shown in FIG. 1, the database 110 stores a plurality of first patent document data items (or may be referred to as a first patent document data group). Preferably, the plurality of first patent document data items may include patent documents of different countries or different fields, but are not limited thereto. The server 120 can receive a first search criterion instruction provided by the user, and can further retrieve a plurality of second patent document data items (or may be referred to as a second patent document data group) from the plurality of first patent document data items based on the first search criterion instruction. In particular, the first search criterion instruction indicates a first search criterion, and the server 120 retrieves the plurality of second patent document data items from the plurality of first patent document data items based on the condition that the plurality of second patent document data items all meet the first search criterion. Next, the server 120 can send the retrieval results (i.e., the plurality of second patent document data items) to the user device 900. Through the display unit of the user device 900, the retrieval results can be displayed for the user to view. The user can read one or more patent document data items (or may be referred to as one or more selected patent document data items) in the plurality of second patent document data items, and give each of the one or more selected patent document data items a corresponding selection instruction. Each selection instruction indicates whether the corresponding selected patent document item is a related patent (i.e., a patent that the user needs) or an unrelated patent (i.e., a patents that the user does not need). In one embodiment, a selection instruction associated with the selected patent document data item may also be associated with a related-tag data item or an unrelated-tag data item. In particular, the related-tag data item indicates that the selected patent document data item is a patent that the user needs or considers relevant, while the unrelated-tag data item indicates that the selected patent document data item is a patent that the user does not need or considers irrelevant. It should be understood that search criteria may include keyword data and/or patent classification code data and/or country data, etc., but are not limited thereto. In addition, search criteria may include different logical operators, such as the logical operator bearing the meaning of “conjunction” (i.e., the logical operator “and”), “disjunction” (i.e., the logical operator “or”), or “negation” (i.e., the logical operator “not”), but are not limited thereto.

The server 120 can obtain a patent classification code data item from a selected patent document data item based on the selected patent document data item and its corresponding selection instruction. Moreover, the server 120 can generate a second search criterion instruction based on at least the first search criterion instruction and the obtained patent classification code data item, wherein the second search criterion instruction includes the obtained patent classification code data item. Preferably, the second search criterion instruction includes the first search criterion instruction, or the second search criterion of the second search criterion instruction includes the first search criterion. Preferably, the server 120 obtains the patent classification code data item from the selected patent document data item based on the condition that the selection instruction for the selected patent document data item is associated with the related-tag data item. That is, the server 120 will only retrieve the patent classification code data item from the selected patent document data item after confirming that the selection instruction for the selected patent document data item is associated with the related-tag data item. Preferably, if the server 120 confirms that the selection instruction for the selected patent document data item is associated with the unrelated-tag data item, the server 120 will not retrieve the patent classification code data item from the selected patent document data item; moreover, the server 120 will not generate a second search criterion instruction based on the patent classification code data item in the selected patent document data item (i.e., the server 120 will not include the patent classification code data item in the selected patent document data item that is associated with the unrelated-tag data item into the second search criterion instruction).

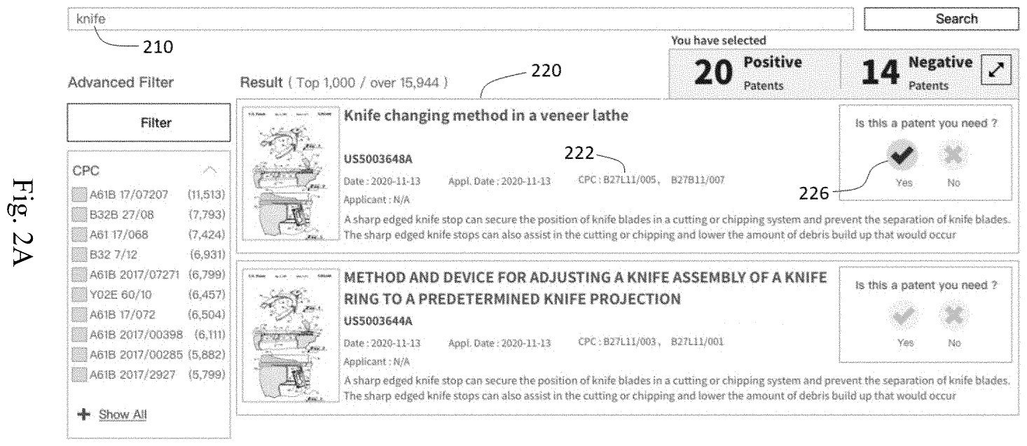

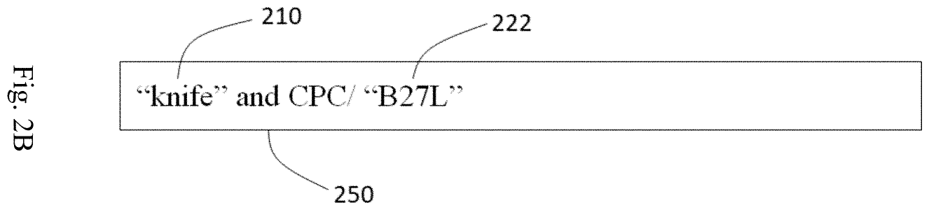

Please refer to FIGS. 2A and 2B, which are schematic views of the patent search system according to an embodiment of the present invention. In the embodiment shown in FIGS. 2A and 2B, the server of the patent search system according to this invention can receive a first search criterion instruction 210 provided by the user, and the server then retrieves a plurality of second patent document data items from the plurality of first patent document data items based on the first search criterion instruction 210. Next, the server can receive a first selection instruction 226 provided by the user; the first selection instruction 226 is associated with a first selected patent document data item 220 in the plurality of second patent document data items. Also, the first selection instruction 226 is associated with the relevant-tag data item, which indicates that the first selected patent document data item 220 is a patent that the user needs or considers to be relevant. The server of the patent search system can obtain a first patent classification code data item 222 from the first selected patent document data item 220 based on the first selection instruction 226. And the server can generate a second search criterion instruction 250 based on at least the first search criterion instruction 210 and the first patent classification code data item 222, wherein the second search criterion instruction 250 includes the first patent classification code data item 222. Further, the server can retrieve a plurality of third patent document data items (or may be referred to as a third patent document data group) from the plurality of first patent document data items based on the second search criterion instruction 250. At least one of the plurality of third patent document data items will include the first patent classification code data item 222. Preferably, the second search criterion instruction 250 indicates a second search criterion, and the server retrieves the plurality of third patent document data items from the plurality of first patent document data items based on the condition that the plurality of third patent document data items all meet the second search criterion. Preferably, the second search criterion includes the first search criterion. Preferably, in the second search criterion instruction 250, the first patent classification code data item 222 is associated with the first search criterion instruction 210 by using a logical operator that means “conjunction” (i.e., the logical operator “and”). Preferably, the first patent classification code data item 222 includes the main patent classification code in the first selected patent document data item 220.

In one embodiment, the patent classification code data item in the second search criterion instruction is used to retrieve, from the plurality of first patent document data item, the patent document data items containing the patent classification code data item (that is, the patent document data items that contain the same patent classification code data item as in the second search criterion instruction). It should be understood that the patent classification code data item contains codes or numbers of certain patent classification system, which may be the International Patent Classification (IPC) system, Cooperative Patent Classification (CPC) system or United States Patent Classification (UPC) system, but is not limited thereto. Preferably, the patent classification code data item is a data item that has a hierarchical structure (that is, the patent classification system shown in this data item adopts a hierarchical structure to classify patent documents). Preferably, a patent document data item may include a plurality of patent classification code data items; for example, a patent document data item may include one or more main patent classification code data items and one or more secondary patent classification code data items. In different embodiments, a patent classification code data item may at least include a first-level patent classification code data item, a second-level patent classification code data item, a third-level patent classification code data item, and a fourth-level patent classification code data item. In different embodiments, a patent classification code data item may at least include a first-level patent classification code data item, a second-level patent classification code data item, a third-level patent classification code data item, a fourth-level patent classification code data item, and a fifth-level patent classification code data item. In different embodiments, a patent classification code data item in a selected patent document data item (such as the first selected patent document data item, but is not limited thereto) is one of a second-level patent classification code data item, a third-level patent classification code data item, a fourth-level patent classification code data item, and a fifth-level patent classification code data item. In different embodiments, a patent classification code data item in a selected patent document data item (such as the first selected patent document data item, but is not limited thereto) can be set as one of a second-level patent classification code data item, a third-level patent classification code data item, a fourth-level patent classification code data item, and a fifth-level patent classification code data item, depending on the needs. For example, in FIG. 2A, the first patent classification code data item 222 includes a third-level patent classification code data item (that is, the first patent classification code data item 222 retrieves the patent classification code data item to the third level, which is “B27L” in the CPC system; meanwhile, the fourth-level patent classification code data item “11” and the fifth-level patent classification code data item “/005” are omitted and are not included in the first patent classification code data item 222).

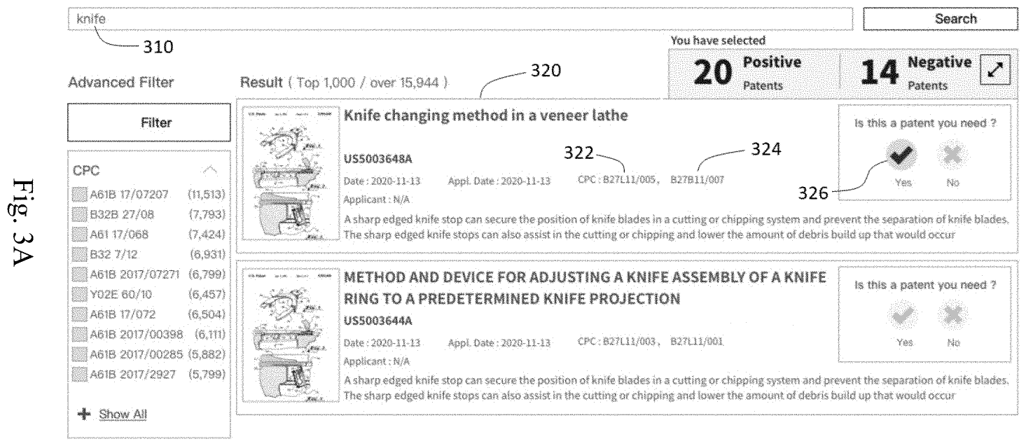

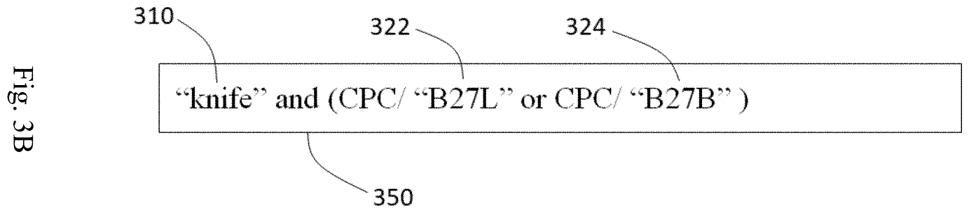

Please refer to FIGS. 3A and 3B, which are schematic views of the patent search system according to an embodiment of the present invention. In the embodiment shown in FIGS. 3A and 3B, the server of the patent search system according to this invention can obtain a first patent classification code data item 322 and a second patent classification code data item 324 from a first selected patent document data item 320 based on a first selection instruction 326 provided by the user. And the server can generate a second search criterion instruction 350 based on at least a first search criterion instruction 310, the first patent classification code data item 322, and the second patent classification code data item 324, wherein the second search criterion instruction 350 includes the first patent classification code data item 322 and the second patent classification code data item 324. Further, the server can retrieve a plurality of third patent document data items from the plurality of first patent document data items based on the second search criterion instruction 350. At least one of the plurality of third patent document data items will include the first patent classification code data item 322, and at least one of the plurality of third patent document data items will include the second patent classification code data item 324. Preferably, the first search criterion instruction 310 indicates a first search criterion, and the second search criterion instruction 350 indicates a second search criterion, which includes the first search criterion, the first patent classification code data item 322 and the second patent classification code data item 324. Preferably, in the second search criterion instruction 350, the first patent classification code data item 322 is associated with the second patent classification code data item 324 by using a logical operator that means “disjunction” (i.e., the logical operator “or”); meanwhile, the first patent classification code data item 322 and the second patent classification code data item 324 are associated with the first search criterion instruction 310 by using a logical operator that means “conjunction” (i.e., the logical operator “and”).

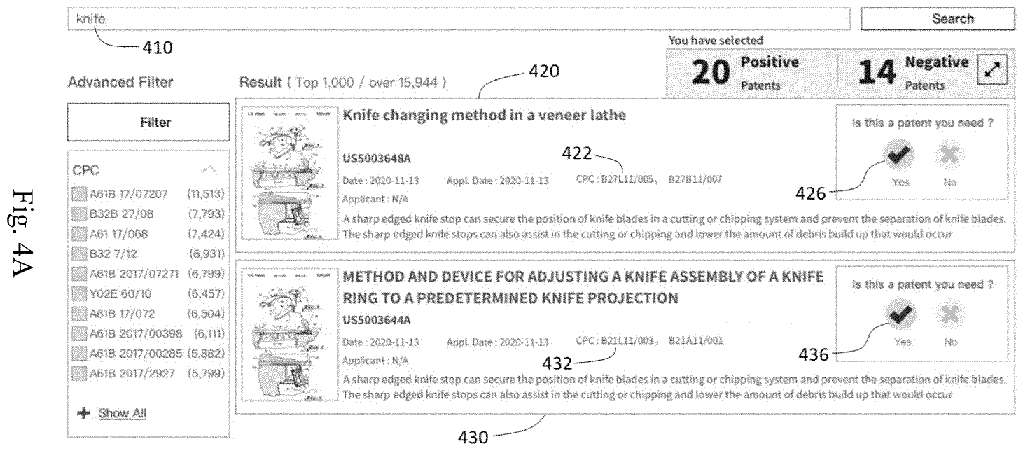

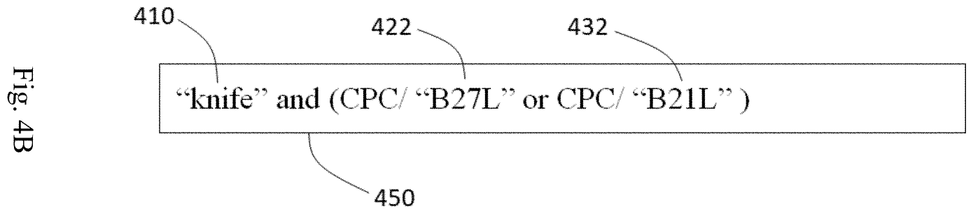

Please refer to FIGS. 4A and 4B, which are schematic views of the patent search system according to an embodiment of the present invention. In the embodiment shown in FIGS. 4A and 4B, the server of the patent search system according to this invention can receive a first selection instruction 426 and a second selection instruction 436 provided by the user. The first selection instruction 426 is associated with a first selected patent document data item 420 in a plurality of second patent document data items, and the second selection instruction 436 is associated with a second selected patent document data item 430 in the plurality of second patent document data items. The server can obtain a first patent classification code data item 422 from the first selected patent document data item 420 based on the first selection instruction 426, and obtain a third patent classification code data item 432 from the second selected patent document data item 430 based on the second selection instruction 436. And the server can generate a second search criterion instruction 450 based on at least a first search criterion instruction 410, the first patent classification code data item 422, and the third patent classification code data item 432, wherein the second search criterion instruction 450 includes the first patent classification code data item 422 and the third patent classification code data item 432. Further, the server can retrieve a plurality of third patent document data items from the plurality of first patent document data items based on the second search criterion instruction 450. At least one of the plurality of third patent document data items will include the first patent classification code data item 422, and at least one of the plurality of third patent document data items will include the third patent classification code data item 432. Preferably, the first search criterion instruction 410 indicates a first search criterion, and the second search criterion instruction 450 indicates a second search criterion, which includes the first search criterion, the first patent classification code data item 422 and the third patent classification code data item 432. Preferably, in the second search criterion instruction 450, the first patent classification code data item 422 is associated with the third patent classification code data item 432 by using a logical operator that means “disjunction” (i.e., the logical operator “or”); meanwhile, the first patent classification code data item 422 and the third patent classification code data item 432 are associated with the first search criterion instruction 410 by using a logical operator that means “conjunction” (i.e., the logical operator “and”).

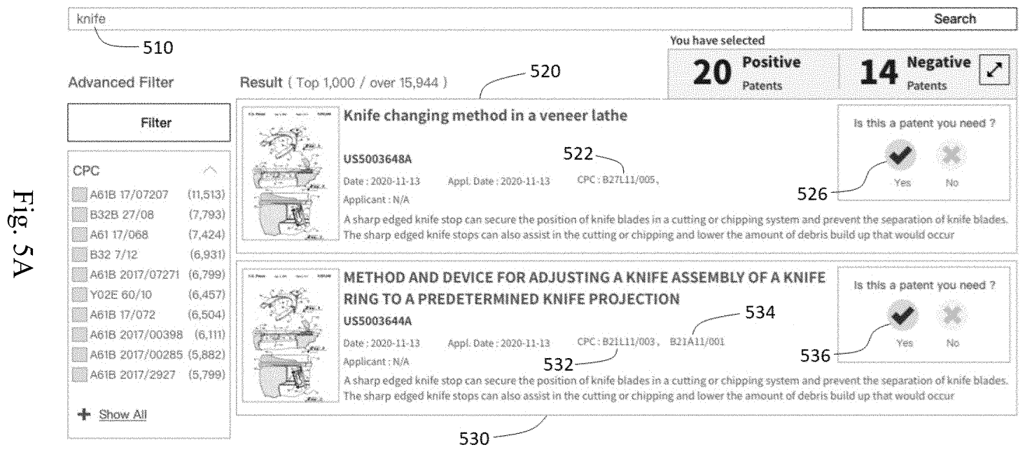

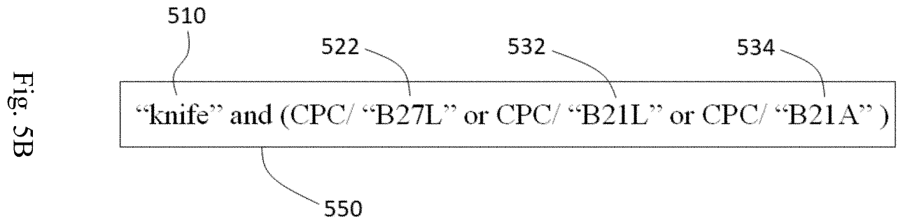

Please refer to FIGS. 5A and 5B, which are schematic views of the patent search system according to an embodiment of the present invention. In the embodiment shown in FIGS. 5A and 5B, the server of the patent search system according to this invention can receive a first selection instruction 526 and a second selection instruction 536 provided by the user. The first selection instruction 526 is associated with a first selected patent document data item 520 in a plurality of second patent document data items, and the second selection instruction 536 is associated with a second selected patent document data item 530 in the plurality of second patent document data items. The server can obtain a first patent classification code data item 522 from the first selected patent document data item 520 based on the first selection instruction 526, and obtain a third patent classification code data item 532 and a fourth patent classification code data item 534 from the second selected patent document data item 530 based on the second selection instruction 536. And the server can generate a second search criterion instruction 550 based on at least a first search criterion instruction 510, the first patent classification code data item 522, and the fourth patent classification code data item 534, wherein the second search criterion instruction 550 includes the first patent classification code data item 522, the third patent classification code data item 532, and the fourth patent classification code data item 534. Further, the server can retrieve a plurality of third patent document data items from the plurality of first patent document data items based on the second search criterion instruction 550. At least one of the plurality of third patent document data items will include the first patent classification code data item 522, at least one of the plurality of third patent document data items will include the third patent classification code data item 532, and at least one of the plurality of third patent document data items will include the fourth patent classification code data item 534. Preferably, the first search criterion instruction 510 indicates a first search criterion, and the second search criterion instruction 550 indicates a second search criterion, which includes the first search criterion, the first patent classification code data item 522, the third patent classification code data item 532, and the fourth patent classification code data item 534. Preferably, in the second search criterion instruction 550, the first patent classification code data item 522, the third patent classification code data item 532, and the fourth patent classification code data item 534 are associated with each other by using a logical operator that means “disjunction” (i.e., the logical operator “or”); meanwhile, the first patent classification code data item 522, the third patent classification code data item 532, and the fourth patent classification code data item 534 are associated with the first search criterion instruction 510 by using a logical operator that means “conjunction” (i.e., the logical operator “and”).

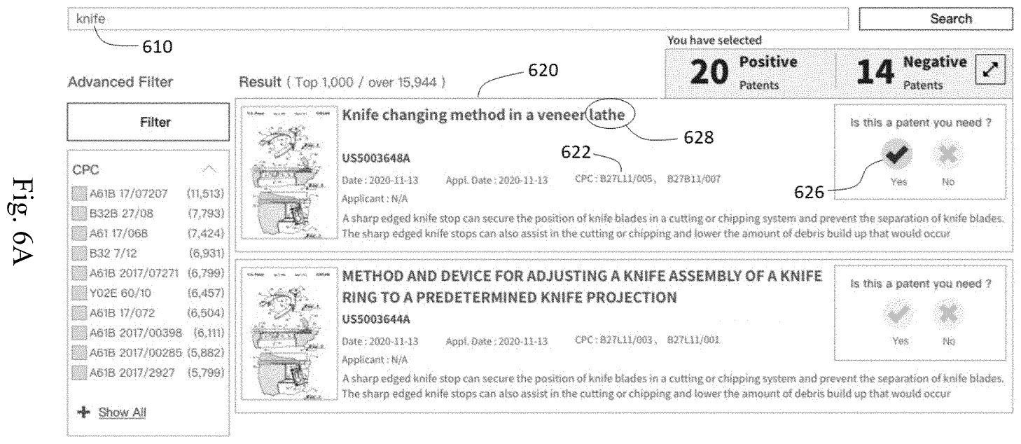

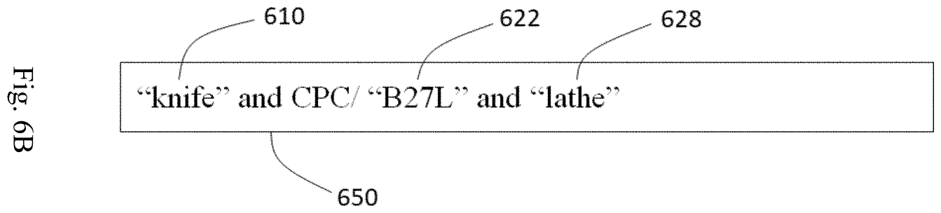

Please refer to FIGS. 6A and 6B, which are schematic views of the patent search system according to an embodiment of the present invention. In the embodiment shown in FIGS. 6A and 6B, the server of the patent search system according to this invention can receive a first selection instruction 626, which is associated with a first selected patent document data item 620 in a plurality of second patent document data items. The server can obtain a first patent classification code data item 622 and a keyword data item 628 from the first selected patent document data item 620 based on the first selection instruction 626. And the server can generate a second search criterion instruction 650 based on at least a first search criterion instruction 610, the first patent classification code data item 622, and the keyword data item 628, wherein the second search criterion instruction 650 includes the first patent classification code data item 622 and the keyword data item 628. Further, the server can retrieve a plurality of third patent document data items from the plurality of first patent document data items based on the second search criterion instruction 650. At least one of the plurality of third patent document data items will include the first patent classification code data item 622, and each of the plurality of third patent document data items will include the keyword data item 628. Preferably, the first search criterion instruction 610 indicates a first search criterion, and the second search criterion instruction 650 indicates a second search criterion, which includes the first search criterion, the first patent classification code data item 622, and the keyword data item 628. Preferably, in the second search criterion instruction 650, the first patent classification code data item 622 and the keyword data item 628 are respectively associated with the first search criterion instruction 610 by using a logical operator that means “conjunction” (i.e., the logical operator “and”). For the method by which the server of the patent search system according to the present invention obtains a keyword data item from a selected patent document data item, please refer to Taiwan Patent Application No. 110138227 (title of the invention: Patent Search System and Method Thereof), which is incorporated herein by reference in its entirety.

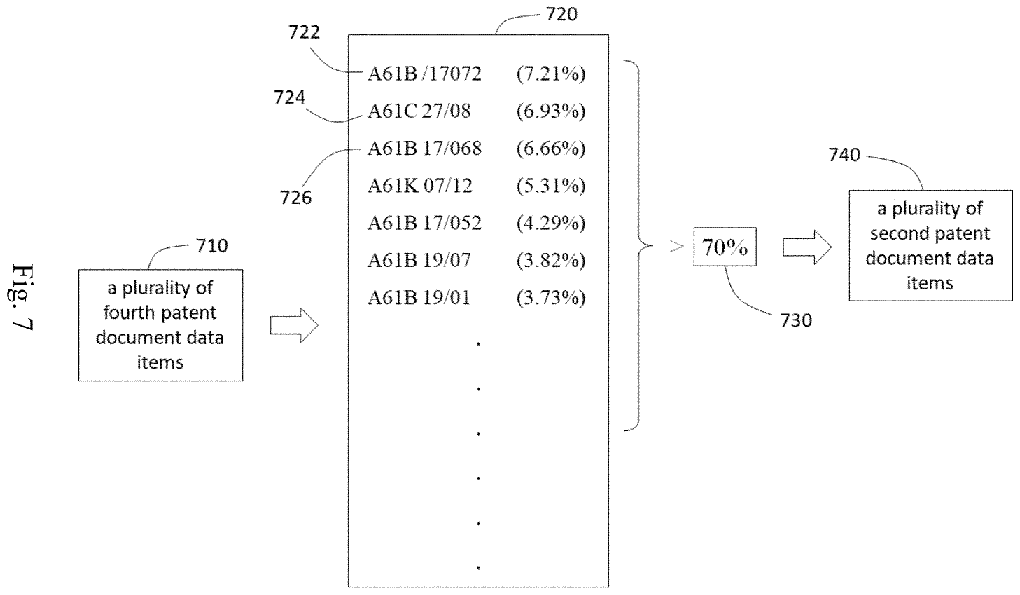

FIG. 7 shows a schematic view of the patent search system according to an embodiment of the present invention. In the embodiment shown in FIG. 7, after receiving a first search criterion instruction provided by the user, the server of the patent search system can retrieve a plurality of fourth patent document data items 710 (or may be referred to as a fourth patent document data group) based on the first search criterion instruction. In particular, the first search criterion instruction indicates a first search criterion, and the server retrieves the plurality of fourth patent document data items from the plurality of first patent document data items in the database based on the condition that the plurality of fourth patent document data items all meet the first search criterion. Moreover, the server can generate a classification ranking data item 720 based on the plurality of fourth patent document data items 710. The classification ranking data item 720 indicates the proportion ranking of different patent classification codes in the plurality of fourth patent document data items 710 (for example, if the total number of patents in the plurality of fourth patent document data items is 1000, and the number of patents with a specific patent classification code in the plurality of fourth patent document data items is 85, then the proportion of data items with this specific patent classification code is 8.5%). Then, the server can retrieve a plurality of second patent document data items 740 from the plurality of fourth patent document data items 710 based on the first search criterion instruction, the classification ranking data item 720, and a predetermined percentage data item 730. The plurality of fourth patent document data items 710 contain the plurality of second patent document data items 740. It should be understood that FIG. 7 only illustrates an exemplary embodiment. The data items included in the classification ranking data item is not limited to fifth-level patent classification code data items; second-level patent classification code data items, third-level patent classification code data items, or fourth-level patent classification code data items can be ranked depending on the needs. In other words, the patent classification code data items included in the classification ranking data item may be set as second-level patent classification code data items, third-level patent classification code data items, fourth-level patent classification code data items, or fifth-level patent classification code data items, depending on the needs.

In one embodiment, first, the server sequentially sums up the percentages corresponding to the respective patent classification code data items in the classification ranking data item 720 until the total percentage of the top N patent classification code data items is greater than the predetermined percentage data item 730. Next, the server retrieves the plurality of second patent document data items from the plurality of first patent document data items based on the first search criterion instruction and the top N patent classification code data items, wherein the plurality of second patent document data items 740 all meet the first search criterion, and each of the plurality of second patent document data items 740 contains one of the top N patent classification code data items. Moreover, the plurality of fourth patent document data items 710 include the plurality of second patent document data items 740. It should be understood that, since a patent document data item containing one of the top N patent classification code data items is more likely to be a patent that the user needs, the search system according to this invention can provide the user with a plurality of second patent document data items that will better meet the user's needs for the user to select therefrom. In this way, the patent document data items that the user needs can be retrieved more efficiently. In one embodiment, the plurality of second patent document data items 740 include a plurality of fifth patent document data items, a plurality of sixth patent document data items, and a plurality of seventh patent document data items. Also, each of the plurality of fifth patent document data items contains (or is associated with) a fifth patent classification code data item 722; each of the plurality of sixth patent document data items contains (or is associated with) a sixth patent classification code data item 724; and each of the plurality of seventh patent document data items contains (or is associated with) a seventh patent classification code data item 726. Specifically, the fifth patent classification code data item 722 ranks first in the classification ranking data item 720; the sixth patent classification code data item 724 ranks second in the classification ranking data item 720; and the seventh patent classification code data item 726 ranks third in the classification ranking data item 720. In addition, at least one of the plurality of second patent document data items 740 contains the fifth patent classification code data item 722; at least one of the plurality of second patent document data items 740 contains the sixth patent classification code data item 724; and at least one of the plurality of second patent document data items 740 contains the seventh patent classification code data item 726.

It should be understood that the patent search system according to this invention can assist the user to gradually narrow down the number of patents in a target patent group through one or more rounds of search during the search process. For example, the user can make selections for the search results of the first round, so that the server can generate the search criterion instruction of the next round (second search criterion instruction) and the corresponding search results (second search results) based on the one or more selection instructions and the corresponding one or more selected patent document data items. Thereafter, for the second search results, the user can repeat the foregoing process to obtain third search results, and repeat the foregoing process for the third search results to obtain fourth search results, and so on, until the user believes that the total number of target patent document data items has satisfied the user's needs.

In one embodiment, after the server of the patent search system according to this invention retrieves a plurality of third patent document data items from the plurality of first patent document data items based on the second search criterion instruction, the server can receive a third selection instruction provided by the user. The third selection instruction is associated with a third selected patent document data item in the plurality of third patent document data items, and is also associated with a third related-tag data item. Next, the server can obtain an eighth patent classification code data item from the third selected patent document data item based on the third selection instruction. And the server can generate a third search criterion instruction based on at least the first search criterion instruction provided by the user and the eighth patent classification code data item, wherein the third search criterion instruction includes the eighth patent classification code data item. Specifically, the first patent classification code data item indicates a first patent classification code, and the eighth patent classification code data item indicates an eighth patent classification code, which belongs to a further detailed classification under the first patent classification code in a hierarchy (for example, if the first patent classification code is a third-level patent classification code, then the eighth patent classification code can be a fourth-level patent classification code or a fifth-level patent classification code related to the first patent classification code.)

Then, the server can retrieve a plurality of eighth patent document data items from the plurality of first patent document data items in the database based on the third search criterion instruction, wherein at least one of the plurality of eighth patent document data items contains the eighth patent classification code data item. Preferably, the third search criterion instruction indicates a third search criterion, and the server retrieves the plurality of eighth patent document data items from the plurality of first patent document data items based on the condition that the plurality of eighth patent document data items all meet the third search criterion. It should be understood that by using the hierarchical characteristics of patent classification codes to gradually retrieve patents under a more detailed classification, the patent search system of the invention can effectively assist users in narrowing down the number of retrieved patents and/or obtaining more precise search results.

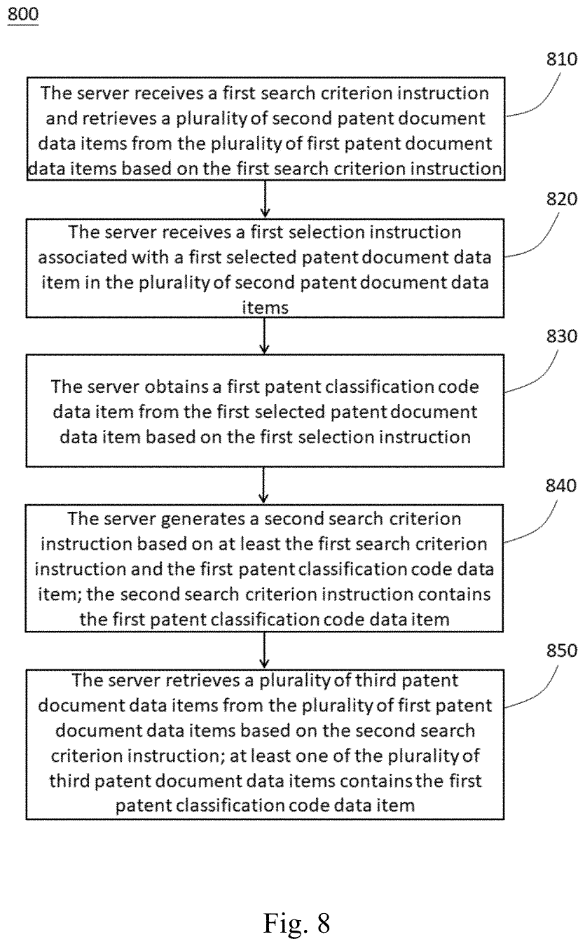

Please refer to FIG. 8, which is a flow chart showing the patent search method according to an embodiment of the present invention. In the embodiment illustrated in FIG. 8, a patent search method 800 for use in a patent search system is provided. The patent search system includes a database and a server; the database stores a plurality of first patent document data items, and the server accesses the database. The patent search method 800 begins at step 810, where the server receives a first search criterion instruction and retrieves a plurality of second patent document data items from the plurality of first patent document data items based on the first search criterion instruction. Specifically, the first search criterion instruction indicates a first search criterion, and the server retrieves the plurality of second patent document data items from the plurality of first patent document data items based on the condition that the plurality of second patent document data items all meet the first search criterion. Next, in step 820, the server receives a first selection instruction, which is associated with a first selected patent document data item in the plurality of second patent document data items. Also, the first selection instruction is associated with a first related-tag data item. Next, in step 830, the server obtains a first patent classification code data item from the first selected patent document data item based on the first selection instruction. Preferably, the first patent classification code data item indicates a first patent classification code, which is the main patent classification code included in the first selected patent document data item. Preferably, the first patent classification code data item is one of a second-level patent classification code data item, a third-level patent classification code data item, a fourth-level patent classification code data item, and a fifth-level patent classification code data item. Next, in step 840, the server generates a second search criterion instruction based on at least the first search criterion instruction and the first patent classification code data item, wherein the second search criterion instruction contains the first patent classification code data item. Next, in step 850, the server retrieves a plurality of third patent document data items from the plurality of first patent document data items based on the second search criterion instruction, and at least one of the plurality of third patent document data items contains the first patent classification code data item. Specifically, the second search criterion instruction indicates a second search criterion, and the server retrieves the plurality of third patent document data items from the plurality of first patent document data items based on the condition that the plurality of third patent document data items all meet the second search criterion.

In one embodiment, the patent search method 800 further includes: obtaining, by the server, a second patent classification code data item from the first selected patent document data item based on the first selection instruction. Specifically, the server generates a second search criterion instruction based on at least the first search criterion instruction, the first patent classification code data item, and the second patent classification code data item, and the second search criterion instruction includes the second patent classification code data item. Moreover, in the plurality of third patent document data items that the server retrieves based on the second search criterion instruction, at least one patent document data item includes the second patent classification code data item. Preferably, the second patent classification code data item indicates a second patent classification code, and this second patent classification code is a secondary patent classification code included in the first selected patent document data item.

In one embodiment, the patent search method 800 further includes: receiving, by the server, a second selection instruction, wherein the second selection instruction is associated with a second selected patent document data item in the plurality of second patent document data items and also associated with a second related-tag data item. The patent search method 800 further includes: obtaining, by the server, a third patent classification code data item from the second selected patent document data item based on the second selection instruction. Specifically, the server generates a second search criterion instruction based on at least the first search criterion instruction, the first patent classification code data item, and the third patent classification code data item, and the second search criterion instruction includes the third patent classification code data item. Moreover, in the plurality of third patent document data items that the server retrieves based on the second search criterion instruction, at least one patent document data item includes the third patent classification code data item.

In another embodiment, in addition to the steps described in the previous embodiment, the patent search method 800 further includes: obtaining, by the server, a fourth patent classification code data item from the second selected patent document data item based on the second selection instruction. Specifically, the server generates a second search criterion instruction based on at least the first search criterion instruction, the first patent classification code data item, the third patent classification code data item, and the fourth patent classification code data item, and the second search criterion instruction includes the fourth patent classification code data item. Moreover, in the plurality of third patent document data items that the server retrieves based on the second search criterion instruction, at least one patent document data item includes the fourth patent classification code data item.

In one embodiment, the patent search method 800 further includes: obtaining, by the server, a keyword data item from the first selected patent document data item based on the first selection instruction. Specifically, the server generates a second search criterion instruction based on at least the first search criterion instruction, the first patent classification code data item, and the keyword data item, and the second search criterion instruction includes the keyword data item. Moreover, in the plurality of third patent document data items that the server retrieves based on the second search criterion instruction, each patent document data item includes the keyword data item.

In one embodiment, the patent search method 800 further includes: retrieving, by the server, a plurality of fourth patent document data items based on the first search criterion instruction, wherein the plurality of fourth patent document data items include the plurality of second patent document data items. The patent search method 800 further includes: generating, by the server, a classification ranking data item based on the plurality of fourth patent document data items, wherein the classification ranking data item indicates the proportion ranking of different patent classification codes in the plurality of fourth patent document data items. Specifically, the server retrieves the plurality of second patent document data items from the plurality of first patent document data items based on the first search criterion instruction, the classification ranking data item, and a predetermined percentage data item. In one embodiment, the plurality of second patent document data items include a plurality of fifth patent document data items, a plurality of sixth patent document data items, and a plurality of seventh patent document data items. Also, each of the plurality of fifth patent document data items contains a fifth patent classification code data item; each of the plurality of sixth patent document data items contains a sixth patent classification code data item; and each of the plurality of seventh patent document data items contains a seventh patent classification code data item. Specifically, the fifth patent classification code data item ranks first in the classification ranking data item; the sixth patent classification code data item ranks second in the classification ranking data item; and the seventh patent classification code data item ranks third in the classification ranking data item. In addition, at least one of the plurality of second patent document data items contains the fifth patent classification code data item; at least one of the plurality of second patent document data items contains the sixth patent classification code data item; and at least one of the plurality of second patent document data items contains the seventh patent classification code data item.

In one embodiment, the patent search method 800 further includes: receiving, by the server, a third selection instruction, wherein the third selection instruction is associated with a third selected patent document data item in the plurality of third patent document data items, and also associated with a third related-tag data item. The patent search method 800 further includes: obtaining, by the server, an eighth patent classification code data item from the third selected patent document data item based on the third selection instruction. Specifically, the first patent classification code data item indicates a first patent classification code, and the eighth patent classification code data item indicates an eighth patent classification code, which belongs to a further detailed classification under the first patent classification code in a hierarchy. The patent search method 800 further includes: generating, by the server, a third search criterion instruction based on at least the first search criterion instruction and the eighth patent classification code data item, wherein the third search criterion instruction includes the eighth patent classification code data item. The patent search method 800 further includes: retrieving, by the server, a plurality of eighth patent document data items from the plurality of first patent document data items based on the third search criterion instruction, wherein at least one of the plurality of eighth patent document data items contains the eighth patent classification code data item. Preferably, the third search criterion instruction indicates a third search criterion, and the server retrieves the plurality of eighth patent document data items from the plurality of first patent document data items based on the condition that the plurality of eighth patent document data items all meet the third search criterion.

The patent search system and the method thereof according to the present invention have been explained through the above description and the accompanying drawings. It should be understood that the above-described embodiments of the invention are provided for explanation purposes. Various modifications can be made without departing from the scope and spirit of the present invention, and such modifications should be considered to be covered by the scope of the claims defining the present invention. Therefore, the embodiments described in this specification are not intended to limit the invention, and the true scope and spirit of the invention are disclosed in the appended claims.

What is claimed is:

1. A patent search system, comprising:
a database storing a plurality of first patent document data items; and
a server accessing the database, the server receiving a first search criterion instruction and then retrieving a plurality of second patent document data items from the plurality of first patent document data items based on the first search criterion instruction,
wherein the server receives a first selection instruction associated with a first selected patent document data item in the plurality of second patent document data items, obtains a first patent classification code data item from the first selected patent document data item based on the first selection instruction, and generates a second search criterion instruction based on at least the first search criterion instruction and the first patent classification code data item, the second search criterion instruction including the first patent classification code data item,
wherein the server retrieves a plurality of third patent document data items from the plurality of first patent document data items based on the second search criterion instruction, and at least one of the plurality of third patent document data items contains the first patent classification code data item,
wherein the first search criterion instruction indicates a first search criterion, and the server retrieves the plurality of second patent document data items from the plurality of first patent document data items on the basis that the plurality of second patent document data items all meet the first search criterion,
wherein the second search criterion instruction indicates a second search criterion, and the server retrieves the plurality of third patent document data items from the plurality of first patent document data items on the basis that the plurality of third patent document data items all meet the second search criterion, and
wherein the first selection instruction is associated with a first related-tag data item.

2. The patent search system of claim 1, wherein the first patent classification code data item is one of a second-level patent classification code data item, a third-level patent classification code data item, a fourth-level patent classification code data item, and a fifth-level patent classification code data item.

3. The patent search system of claim 1, wherein the server obtains a second patent classification code data item from the first selected patent document data item based on the first selection instruction,
wherein the server generates the second search criterion instruction based on at least the first search criterion instruction, the first patent classification code data item, and the second patent classification code data item, and the second search criterion instruction includes the second patent classification code data item, and
wherein at least one of the plurality of third patent document data items contains the second patent classification code data item.

4. The patent search system of claim 1, wherein the server receives a second selection instruction associated with a second selected patent document data item in the plurality of second patent document data items, and the server obtains a third patent classification code data item from the second selected patent document data item based on the second selection instruction,
wherein the server generates the second search criterion instruction based on at least the first search criterion instruction, the first patent classification code data item, and the third patent classification code data item, and the second search criterion instruction includes the third patent classification code data item,
wherein at least one of the plurality of third patent document data items contains the third patent classification code data item, and
wherein the second selection instruction is associated with a second related-tag data item.

5. The patent search system of claim 4, wherein the server obtains a fourth patent classification code data item from the second selected patent document data item based on the second selection instruction,
wherein the server generates the second search criterion instruction based on at least the first search criterion instruction, the first patent classification code data item, the third patent classification code data item, and the fourth patent classification code data item, and the second search criterion instruction includes the fourth patent classification code data item, and
wherein at least one of the plurality of third patent document data items contains the fourth patent classification code data item.

6. The patent search system of claim 1, wherein the server obtains a keyword data item from the first selected patent document data item based on the first selection instruction, and the server generates the second search criterion instruction based on at least the first search criterion instruction, the first patent classification code data item, and the keyword data item, the second search criterion instruction including the keyword data item.

7. The patent search system of claim 1, wherein the server retrieves a plurality of fourth patent document data items based on the first search criterion instruction and generates a classification ranking data item based on the plurality of fourth patent document data items, the classification ranking data item indicating a proportion ranking of different patent classification codes in the plurality of fourth patent document data items,
wherein the server retrieves the plurality of second patent document data items from the plurality of first patent document data items based on the first search criterion instruction, the classification ranking data item, and a predetermined percentage data item, and
wherein the plurality of fourth patent document data items include the plurality of second patent document data items.

8. The patent search system of claim 7, wherein the plurality of second patent document data items include a plurality of fifth patent document data items, a plurality of sixth patent document data items, and a plurality of seventh patent document data items, each of the plurality of fifth patent document data items contains a fifth patent classification code data item, each of the plurality of sixth patent document data items contains a sixth patent classification code data item, and each of the plurality of seventh patent document data items contains a seventh patent classification code data item,
wherein the fifth patent classification code data item ranks first in the classification ranking data item, the sixth patent classification code data item ranks second in the classification ranking data item, and the seventh patent classification code data item ranks third in the classification ranking data item, and
wherein at least one of the plurality of second patent document data items contains the fifth patent classification code data item, at least one of the plurality of second patent document data items contains the sixth patent classification code data item, and at least one of the plurality of second patent document data items contains the seventh patent classification code data item.

9. The patent search system of claim 1, wherein the server receives a third selection instruction associated with a third selected patent document data item in the plurality of third patent document data items and obtains an eighth patent classification code data item from the third selected patent document data item based on the third selection instruction, and the server generates a third search criterion instruction based on at least the first search criterion instruction and the eighth patent classification code data item, the third search criterion instruction including the eighth patent classification code data item,
wherein the third selection instruction is associated with a third related-tag data item,
wherein the server retrieves a plurality of eighth patent document data items from the plurality of first patent document data items based on the third search criterion instruction, and at least one of the plurality of eighth patent document data items contains the eighth patent classification code data item,
wherein the third search criterion instruction indicates a third search criterion, and the server retrieves the plurality of eighth patent document data items from the plurality of first patent document data items on the basis that the plurality of eighth patent document data items all meet the third search criterion, and
wherein the first patent classification code data item indicates a first patent classification code, and the eighth patent classification code data item indicates an eighth patent classification code, which belongs to a further detailed classification under the first patent classification code in a hierarchy.

10. A patent search method for use in a patent search system, the patent search system comprising a database and a server, the database storing a plurality of first patent document data items, the server accessing the database, the patent search method including the steps of:
receiving, by the server, a first search criterion instruction and retrieving a plurality of second patent document data items from the plurality of first patent document data items based on the first search criterion instruction;
receiving, by the server, a first selection instruction associated with a first selected patent document data item in the plurality of second patent document data items;
obtaining, by the server, a first patent classification code data item from the first selected patent document data item based on the first selection instruction;
generating, by the server, a second search criterion instruction based on at least the first search criterion instruction and the first patent classification code data item, the second search criterion instruction including the first patent classification code item; and
retrieving, by the server, a plurality of third patent document data items from the plurality of first patent document data items based on the second search criterion instruction, at least one of the plurality of third patent document data items containing the first patent classification code data item,
wherein the first search criterion instruction indicates a first search criterion, and the server retrieves the plurality of second patent document data items from the plurality of first patent document data items on the basis that the plurality of second patent document data items all meet the first search criterion,
wherein the second search criterion instruction indicates a second search criterion, and the server retrieves the plurality of third patent document data items from the plurality of first patent document data items on the basis that the plurality of third patent document data items all meet the second search criterion, and
wherein the first selection instruction is associated with a first related-tag data item.

11. The patent search method of claim 10, wherein the first patent classification code data item is one of a second-level patent classification code data item, a third-level patent classification code data item, a fourth-level patent classification code data item, and a fifth-level patent classification code data item.

12. The patent search method of claim 10, further including:
obtaining, by the server, a second patent classification code data item from the first selected patent document data item based on the first selection instruction,
wherein the server generates the second search criterion instruction based on at least the first search criterion instruction, the first patent classification code data item, and the second patent classification code data item, and the second search criterion instruction includes the second patent classification code data item, and
wherein at least one of the plurality of third patent document data items contains the second patent classification code data item.

13. The patent search method of claim 10, further including:
receiving, by the server, a second selection instruction associated with a second selected patent document data item in the plurality of second patent document data items; and
obtaining, by the server, a third patent classification code data item from the second selected patent document data item based on the second selection instruction,
wherein the server generates the second search criterion instruction based on at least the first search criterion instruction, the first patent classification code data item, and the third patent classification code data item, and the second search criterion instruction includes the third patent classification code data item,
wherein at least one of the plurality of third patent document data items contains the third patent classification code data item, and
wherein the second selection instruction is associated with a second related-tag data item.

14. The patent search method of claim 13, further including:
obtaining, by the server, a fourth patent classification code data item from the second selected patent document data item based on the second selection instruction,
wherein the server generates the second search criterion instruction based on at least the first search criterion instruction, the first patent classification code data item, the third patent classification code data item, and the fourth patent classification code data item, and the second search criterion instruction includes the fourth patent classification code data item, and
wherein at least one of the plurality of third patent document data items contains the fourth patent classification code data item.

15. The patent search method of claim 10, further including:
obtaining, by the server, a keyword data item from the first selected patent document data item based on the first selection instruction,
wherein the server generates the second search criterion instruction based on at least the first search criterion instruction, the first patent classification code data item, and the keyword data item, the second search criterion instruction including the keyword data item.

16. The patent search method of claim 10, further including:
retrieving, by the server, a plurality of fourth patent document data items based on the first search criterion instruction; and
generating, by the server, a classification ranking data item based on the plurality of fourth patent document data items, the classification ranking data item indicating a proportion ranking of different patent classification codes in the plurality of fourth patent document data items,
wherein the server retrieves the plurality of second patent document data items from the plurality of first patent document data items based on the first search criterion instruction, the classification ranking data item, and a predetermined percentage data item, and
wherein the plurality of fourth patent document data items include the plurality of second patent document data items.

17. The patent search method of claim 16, wherein the plurality of second patent document data items include a plurality of fifth patent document data items, a plurality of sixth patent document data items, and a plurality of seventh patent document data items, each of the plurality of fifth patent document data items contains a fifth patent classification code data item, each of the plurality of sixth patent document data items contains a sixth patent classification code data item, and each of the plurality of seventh patent document data items contains a seventh patent classification code data item,
wherein the fifth patent classification code data item ranks first in the classification ranking data item, the sixth patent classification code data item ranks second in the classification ranking data item, and the seventh patent classification code data item ranks third in the classification ranking data item, and
wherein at least one of the plurality of second patent document data items contains the fifth patent classification code data item, at least one of the plurality of second patent document data items contains the sixth patent classification code data item, and at least one of the plurality of second patent document data items contains the seventh patent classification code data item.

18. The patent search method of claim 10, further including:
receiving, by the server, a third selection instruction associated with a third selected patent document data item in the plurality of third patent document data items;
obtaining, by the server, an eighth patent classification code data item from the third selected patent document data item based on the third selection instruction;
generating, by the server, a third search criterion instruction based on at least the first search criterion instruction and the eighth patent classification code data item, the third search criterion instruction including the eighth patent classification code data item; and
retrieving, by the server, a plurality of eighth patent document data items from the plurality of first patent document data items based on the third search criterion instruction, at least one of the plurality of eighth patent document data items containing the eighth patent classification code data item,
wherein the third selection instruction is associated with a third related-tag data item,
wherein the third search criterion instruction indicates a third search criterion, and the server retrieves the plurality of eighth patent document data items from the plurality of first patent document data items on the basis that the plurality of eighth patent document data items all meet the third search criterion, and
wherein the first patent classification code data item indicates a first patent classification code, and the eighth patent classification code data item indicates an eighth patent classification code, which belongs to a further detailed classification under the first patent classification code in a hierarchy.
